(19) United States
(12) Patent Application Publication
(10) Pub. No.: US 2024/0055825 A1
(43) Pub. Date: Feb. 15, 2024

(54) CONTROL SYSTEM FOR A LASER SOURCE AND METHOD FOR CONTROLLING AN OUTPUT POWER OF THE LASER SOURCE

(71) Applicant: GIP TECHNOLOGY CORPORATION, New Taipei City (TW)

(72) Inventors: Hou-Jen Chen, New Taipei City (TW); Wei-Chi Liu, New Taipei City (TW); Feng-Ming Kuo, New Taipei City (TW); Min-Ju Lee, New Taipei City (TW); Po-Hsiu Yen, New Taipei City (TW); Sung-Yuen Wang, New Taipei City (TW)

(21) Appl. No.: 17/885,174

(22) Filed: Aug. 10, 2022

(51) Int. Cl. H01S 3/131; H01S 3/091; H01S 3/13

(52) U.S. Cl. CPC H01S 3/1312; H01S 3/0912; H01S 3/1305

(57) ABSTRACT

A control system for a laser source includes a light extraction unit connected to a signal transmission port of a pump combiner of the laser source, and a microprocessor. The signal transmission port detects a leakage light signal from an optical resonator via the pump combiner to obtain a light parameter. The microprocessor unit is configured to determine an output power of the output laser signal based on the light parameter, and when it is determined that the output power differs from a preset power value, transmit an adjustment signal for adjusting an input power supplied to a plurality of pump sources.

### FIELD

The disclosure relates to a control system for a laser source and a method for controlling an output power of the laser source.

### BACKGROUND

FIG. 1 is a block diagram of a conventional laser source 100. The laser source 100 includes a power supply 102, a processing unit 104 connected to the power supply 102, a plurality of pump sources 106 that receive an input power from the power supply 102 via the processing unit 104, a pump combiner 108 that includes a plurality of input ports 108a connected respectively to the plurality of pump sources 106, and an optical resonator 110 that receives pump light from the pump combiner 108. The optical resonator 110 includes a high-reflective element 112, an output coupler element 114, and a gain medium element 116 disposed between the high-reflective element 112 and the output coupler element 114. The optical resonator 110 further determines the output laser signal based on the high-reflective element 112, the output coupler element 114 and the gain medium element 116.

In use, to measure an output power of the output laser signal, an optical splitter 122 (a reflective mirror, a fiber optic splitter, etc.) is placed in the path of the output laser signal, so as to extract a split signal (i.e., a portion of the output laser signal reflected by the optical splitter 122), and a photodetector 120 is placed in the path of the split light signal to measure a power of the split signal. It is noted that, since the power of the split signal is a portion of the output power of the output laser signal, and the portion is pre-determined by the optical splitter 122 (based on the intended use of the laser source 100, the optical splitter 122 may be configured such that the power of the split signal is 0.1% to 1% of the output power of the output laser signal), the output power of the output laser signal may be calculated based on the power of the split signal measured by the photodetector 120.

Generally, in the cases where the laser source 100 is operating with a relatively greater output power, a fiber optic splitter would be unsuitable to serve as the optical splitter 122, and a reflective mirror configured to reflect 0.1% of the output power of the output laser signal may be employed as the optical splitter 122.

### SUMMARY

One object of the disclosure is to provide a control system for a laser source where the control system is configured to measure an output power of an output laser signal of the laser source, and to adjust an input power to ensure that the output power of the output laser signal is stable.

According to one embodiment of the disclosure, the control system is for a laser source. The laser source includes a processing unit, a plurality of pump sources that are connected to and controlled by the processing unit to output a light signal, a pump combiner that includes a plurality of input ports connected to the plurality of pump sources, respectively, and a signal transmission port, an optical resonator that receives pump light from the pump combiner and that outputs an output laser signal. The control system includes a light extraction unit and a microprocessor unit.

The light extraction unit is connected to the signal transmission port, and is configured to detect a leakage light signal from the optical resonator via the pump combiner to obtain a light parameter associated with the leakage light signal.

The microprocessor unit is connected to the light extraction unit to receive the light parameter from the light extraction unit and is configured to determine an output power of the output laser signal based on the light parameter.

The microprocessor unit is further connected to the processing unit, and is configured to determine whether the output power of the output laser signal differs from a preset power value, and when it is determined that the output power of the output laser signal differs from the preset power value, transmit an adjustment signal to the processing unit, so as to enable the processing unit to adjust an input power supplied to the plurality of pump sources in a manner that the input power results in the output power of the output laser signal being equal to the preset power value.

Another object of the disclosure is to provide a method for controlling the output power of the laser source.

According to one embodiment of the disclosure, the method is for controlling a laser source. The laser source includes a processing unit, a plurality of pump sources that are connected to and controlled by the processing unit to output a light signal, a pump combiner that includes a plurality of input ports connected to the plurality of pump sources, respectively, and an optical resonator that receives pump light from the pump combiner and that outputs an output laser signal. The method is implemented using a control system connected to one of the input ports and includes steps of:
a) detecting a leakage light signal from the optical resonator via the pump combiner, and obtaining a light parameter associated with the leakage light signal;
b) determining an output power of the output laser signal based on the light parameter;
c) determining whether the output power of the output laser signal differs from a preset power value; and
d) when it is determined that the output power of the output laser signal differs from the preset power value, transmitting an adjustment signal to the processing unit, so as to enable the processing unit to adjust an input power supplied to the pump sources in a manner that results in the output power of the output laser signal being equal to the preset power value.

### BRIEF DESCRIPTION OF THE DRAWINGS

Other features and advantages of the disclosure will become apparent in the following detailed description of the embodiments with reference to the accompanying drawings, of which:

FIG. 1 a block diagram of a conventional laser source;

FIG. 2 is a block diagram of a control system for a laser source according to one embodiment of the disclosure;

FIG. 3 is a block diagram illustrating components of the control system according to one embodiment of the disclosure;

FIG. 4 is a block diagram illustrating a configuration for measuring an absolute value of an output power of an output laser signal and a corresponding light parameter;

FIG. 5 is a flow chart illustrating steps of a method for controlling an output power of a laser source according to one embodiment of the disclosure; and

FIG. 6 is a block diagram of a control system for a laser source according to one embodiment of the disclosure.

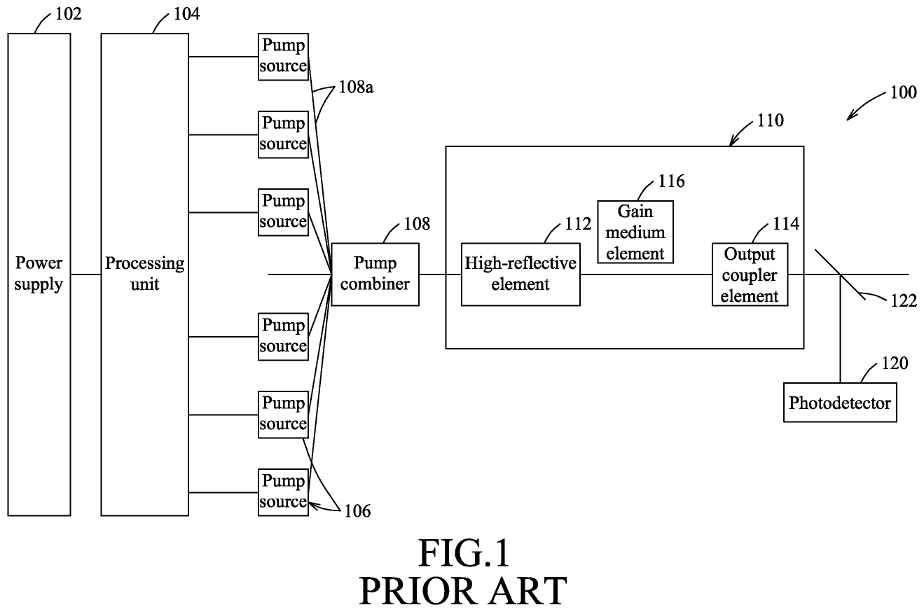

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical or optical apparatus/devices/equipment via an electrically conductive material (e.g., an electrical wire) or light-guiding material, or an indirect connection between two electrical or optical apparatus/devices/equipment via another one or more apparatus/devices/equipment, or wireless communication.

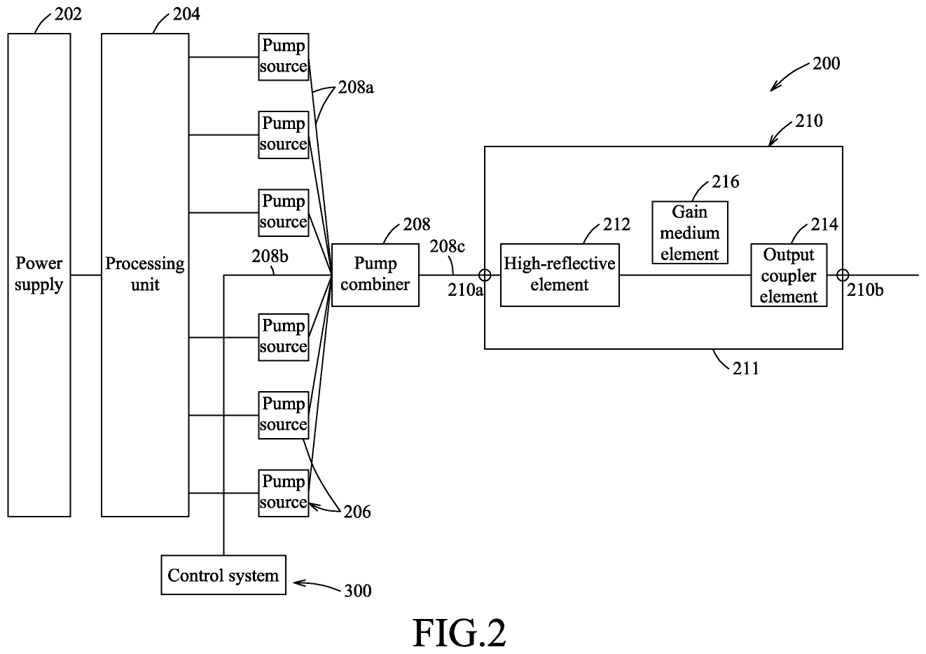

FIG. 2 is a block diagram of a control system 300 for a laser source 200 according to one embodiment of the disclosure.

In this embodiment, the laser source 200 includes a power supply 202, a processing unit 204 connected to the power supply 202, a plurality of pump sources 206 that receive an input power from the processing unit 204, a pump combiner 208, and an optical resonator 210. The pump combiner 208 includes a plurality of input ports 208a connected respectively to the plurality of pump sources 206, a signal transmission port 208b, and an output port 208c. Light outputted by the output port 208c of the pump combiner 208 may be referred to as “pump light”. The optical resonator 210 receives pump light from the pump combiner 208 and outputs an output laser signal. The optical resonator 210 may include a container 211 that defines a cavity, a high-reflective element 212 and an output coupler element 214 that are disposed respectively at two ends of the cavity, and a gain medium element 216 that is disposed in the cavity between the high-reflective element 212 and the output coupler element 214. In embodiments, additional optical elements such as a coated lens, a coated mirror, or a fiber grating may be included in the optical resonator 210.

In different embodiments, the laser source 200 may be embodied using a fiber laser (in which the gain medium element 216 is an optical fiber doped with rare-earth elements), a free-space laser used in free-space optic (FSO) communication, or other configurations to be utilized in various applications.

The processing unit 204 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc. The processing unit 204 is configured to receive an input voltage from the power supply 202, to generate the input power from the input voltage based on the input voltage, and to output the input power to the pump sources 206. In this embodiment, the processing unit 204 may include a driving circuit configured to generate a driving current that is to be fed into each of the pump sources 206 as the input power.

The pump sources 206 may be embodied using flashlamps, arc lamps, semiconductor diode laser or other high-brightness laser sources (such as fiber laser, diode pump solid state laser). In response to receipt of the input power, each of the pump sources 206 emits light. It is noted that the operations of the pump sources 206 are widely known in the relevant field, and details thereof are omitted herein for the sake of brevity.

The pump combiner 208 is connected to the pump sources 206, and combines the light emitted from the pump sources 206 to output combined light to the optical resonator 210. In the embodiment of FIG. 2, six pump sources 206 are present, and the pump combiner 208 has a (6+1)*1 configuration (i.e., with six input ports 208a, one signal transmission port 208b, and one output port 208c). Each of the six input ports 208a may be embodied using an optical fiber connected to a fiber-coupled diode device, and the output port 208c may be embodied using an optical fiber, but other materials may be employed for combining the light emitted by the pump sources 206.

It is noted that in other embodiments, other configurations of the pump combiner 208 (e.g., (12+1)*1, (16+1)*1, etc.) may be employed to accommodate various numbers of pump sources 206. In other embodiments, various manners for combining the light emitted by the pump sources 206 may be employed, and the disclosure is not limited as described above.

The optical resonator 210 has an input node 210a connected to the output port 208c of the pump combiner 208, and an output node 210b for outputting the output laser signal.

The high-reflective element 212 is placed near the input node 210a, and may be embodied using a high reflector fiber Bragg grating (HR-FBG) in this embodiment, but may be other elements such as a high-reflective mirror in the cases that the laser source 200 is the free-space laser used in FSO communication.

The output coupler element 214 is placed near the output node 210b, may be embodied using an output coupler fiber Bragg grating (OC-FBG) with a low reflectivity, but may be other elements such as an output coupler mirror with a reflectivity (R) of about 10% (i.e., about 90% of the light propagates through the output coupler mirror) in the cases that the laser source 200 is the free-space laser used in FSO communication.

In this embodiment, the gain medium element 216 is an optical fiber doped with rare-earth elements, such as Ytterbium, Erbium, etc. In other embodiments, Nd:YAG (neodymium-doped yttrium aluminum garnet), Nd:YVO4 (neodymium doped yttrium Vanadate), YB:YAG (ytterbium doped yttrium aluminum garnet) or Er:YAG (erbium-doped yttrium aluminum garnet) may also be used as a lasing medium.

In response to the combined pump light from the pump combiner 208, the optical resonator 210 outputs the output laser signal at the output node 210b. It is noted that the operation of the optical resonator 210 is widely known in the relevant field, and details thereof are omitted herein for the sake of brevity.

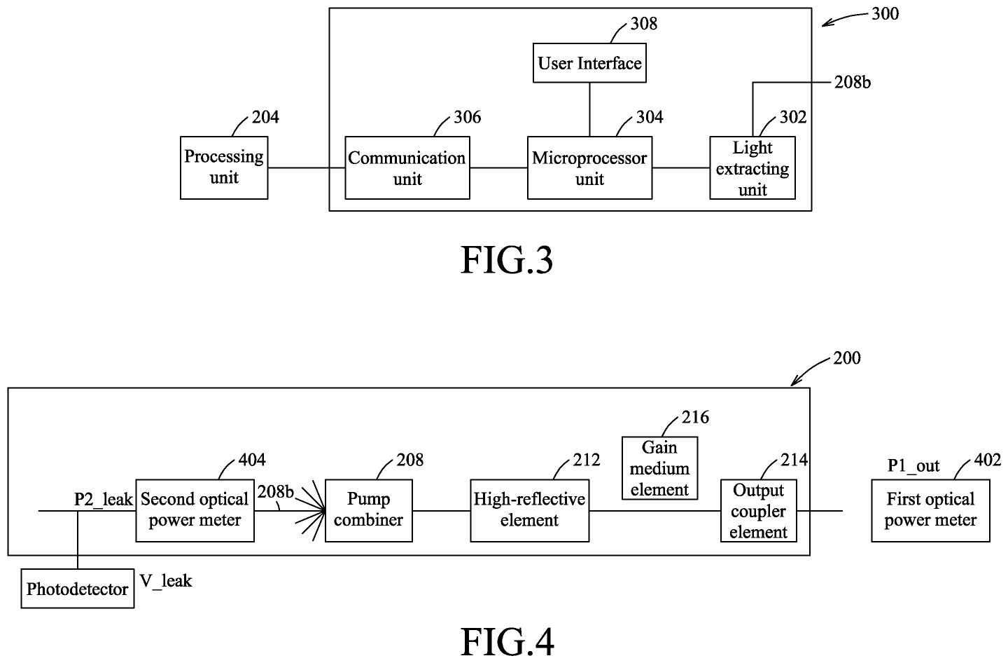

Further referring to FIG. 3, the control system 300 includes a light extracting unit 302, a microprocessor unit 304, a communication unit 306 and a user interface 308.

The light extracting unit 302 is connected to the signal transmission port 208b using, for example, an optical fiber. The light extraction unit 302 is configured to detect a leakage light signal from the optical resonator 210 via the pump combiner 208 to obtain a light parameter associated with the leakage light signal.

Specifically, it is noted that when the light propagates within the optical resonator 210, a portion of the light leaks out via the input node 210a (and back into the pump combiner 208) as the leakage light signal. As a result, by connecting the light extraction unit 302 to the signal transmission port 208b of the pump combiner 208, the leakage light signal may be received and detected.

In this embodiment, the light extracting unit 302 is embodied using a voltage measuring circuit that includes a measuring component such as a photodiode, and the light parameter obtained by the light extracting unit 302 is a leakage voltage. Alternatively, in other embodiments, the light extracting unit 302 may include a wattmeter, and the light parameter obtained by the light extracting unit 302 may be electrical power.

The microprocessor unit 304 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

The microprocessor unit 304 is connected to the processing unit 204 via the communication unit 306, and is connected to the light extraction unit 302 to receive the light parameter from the light extraction unit 302, and is configured to determine an output power of the output laser signal based on the light parameter.

Specifically, in this embodiment, a correspondence between the light parameter and corresponding output power of the output laser signal may be pre-stored in a memory component of the microprocessor unit 304 in the form of a lookup table or form of a polynomial equation relationship. The lookup table or the polynomial equation relationship indicating the correspondence between the light parameter and the corresponding output power of the output laser signal may be constructed using a manner as described below.

Referring to FIG. 4, for a specific laser source (e.g., the laser source 200 as shown in FIG. 2), a first optical power meter 402 may be placed on the path of the output laser signal. The first optical power meter 402 may be a commercially available laser power meter that is configured to measure an absolute value of an output power of the output laser signal (labeled as P1_out). Simultaneously, a second optical power meter 404 may be connected to the signal transmission port 208b so as to measure an absolute value of the output power of the leakage light signal (labeled as P2_leak), and the control system 300 is configured to receive the leakage light signal to obtain the light parameter (the leakage voltage, labeled V_leak). It is noted that the operations of optical power meters are readily known in the related field, and details thereof are omitted herein for the sake of brevity.

In this configuration, a specific input power (which may be in the form of driving currents) may be fed to the pump sources 206, and in turn, light is generated and transmitted through the pump combiner 208 and into the optical resonator 210, which results in the output laser signal and leakage light signal.

Correspondingly, under the specific input power, a set of source data may be obtained and recorded. The set of source data includes the value of the input power, the corresponding output power of the output laser signal, the corresponding output power of the leakage light signal and the corresponding light parameter (V_leak). The above operation may be repeated for a number of times, each with a different value of input power and resulting in a different set of source data.

Afterward, for the specific laser source 200, the lookup table or the polynomial equation relationship indicating a relationship among the input power, the output power and the light parameter may then be constructed using the sets of source data and stored in a data storage component of the microprocessor unit 304. The data storage component may be embodied using, for example, random access memory (RAM), read only memory (ROM), programmable ROM (PROM), firmware, and/or flash memory, etc. Using the lookup table or the polynomial equation relationship, a relationship among the input power, the output power, and the light parameter (V_leak) with respect to the laser source 200 may be obtained.

The communication unit 306 may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) and/or fifth generation (5G) of wireless mobile telecommunications technology, or the like. In this embodiment, the communication unit 306 enables the microprocessor unit 304 to establish communication with the processing unit 204.

The user interface 308 may include a touch screen, a keypad, or other components that enable a user to interact with the control system 300.

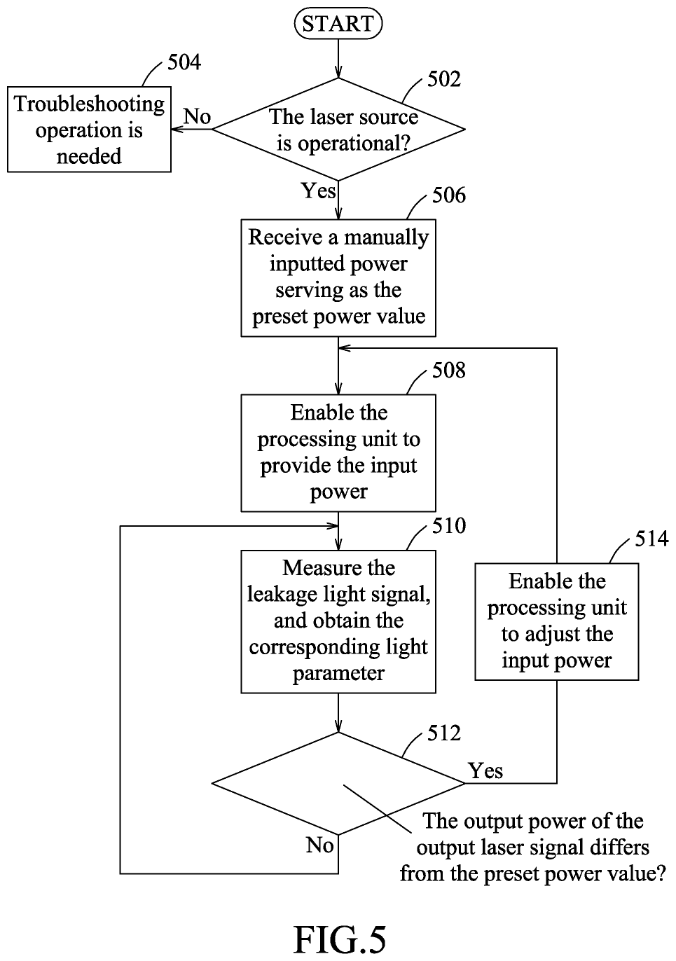

FIG. 5 is a flow chart illustrating steps of a method for controlling an output power of a laser source according to one embodiment of the disclosure. In this embodiment, the method is implemented using the control system 300 shown in FIG. 3 connected to the laser source 200 as shown in FIG. 2. It is noted that the second optical power meter 404 is only present in the stage of constructing correspondence between the light parameter and the corresponding output power of the output laser signal, and is not used in the implementation of this method.

In step 502, after the laser source 200 is powered (i.e., the power supply 202 is activated), the control system 300 determines whether the laser source 200 is operating normally. Specifically, the microprocessor unit 304 may determine whether the leakage light signal is received by the light extraction unit 302, or may employ other measures to determine whether the laser source 200 is operating normally. When it is determined that the laser source 200 is operating normally (i.e., no major alarm is received such as a water temperature alarm, a water flow rate alarm, a dew point alarm, an ambient temperature alarm, a power supply abnormal alarm, etc.), the flow proceeds to step 506. Otherwise, the flow proceeds to step 504, where the microprocessor unit 304 outputs an alert (e.g., an audio, a flashing light and/or a text message on a display screen) to notify a user that the laser source 200 is not operational, and a troubleshooting operation is needed.

In step 506, the control system 300 receives a preset power value that is manually inputted by a user via the user interface 308.

In step 508, in response to the preset power value, the microprocessor unit 304 obtains a corresponding value of input power, and transmits an adjustment signal to the processing unit 204, so as to enable the processing unit 204 to provide the input power with the corresponding value to the pump sources 206.

Then, in step 510, when the laser source 200 is in use, the control system 300 continuously measures the leakage light signal, and obtains the corresponding light parameter. Based on the light parameter, the microprocessor unit 304 further obtains the corresponding output power of the output laser signal according to the lookup table or the polynomial equation relationship that is pre-stored in the memory component of the microprocessor unit 304.

Then, in step 512, the microprocessor unit 304 compares the output power of the output laser signal and the preset power value to determine whether the output power of the output laser signal differs from the preset power value. When it is determined that the output power of the output laser signal differs from the preset power value, the flow proceeds to step 514. In step 514, the microprocessor unit 304 transmits an adjustment signal to the processing unit 204, so as to enable to the processing unit 204 to adjust the input power to the pump sources 206 in a manner that results in the output power of the output laser signal being equal to the preset power value.

When it is determined that the output power of the output laser signal is not different from the preset power value, the flow may go back to step 510 to continuously measure the leakage light signal so long as the laser source 200 is in use.

In embodiments, the above operations in steps 508, 510, 512 and 514 may be implemented in a number of ways. In one example, the microprocessor unit 304 may include a circuit block that is configured to perform the above operations. In other examples, the memory component of the microprocessor unit 304 may store firmware instructions that, when executed by the microprocessor unit 304, cause the microprocessor unit 304 to perform the above operations. It is noted that using the hardware circuit blocks may yield a shorter response time.

In use, because of effects such as a temperature change, the output power of the output laser signal may differ from the preset power value. In such cases, the microprocessor unit 304 is capable of causing the processing unit 204 to adjust the input power, so as to keep the output power of the output laser signal stable at the preset power value.

In some embodiments, the microprocessor unit 304 is further configured to perform the operations of, when it is determined that a difference between the output power of the output laser signal and the preset power value is larger than a preset threshold, transmitting a stop signal to the processing unit 204, so as to enable to the processing unit 204 to stop transmitting the input power to each of the plurality of pump sources 206.

In one example, when the output power of the output laser signal becomes lower than about 300 watts (the original operating power is set to 600 watts), it may be deduced that one or more components of the laser source 200 has malfunctioned, and the operations should be stopped so as to prevent further damages to the laser source 200. In such cases, the microprocessor unit 304 transmits the stop signal to the processing unit 204, so as to enable the processing unit 204 to stop transmitting the input power to every single one of the pump sources 206.

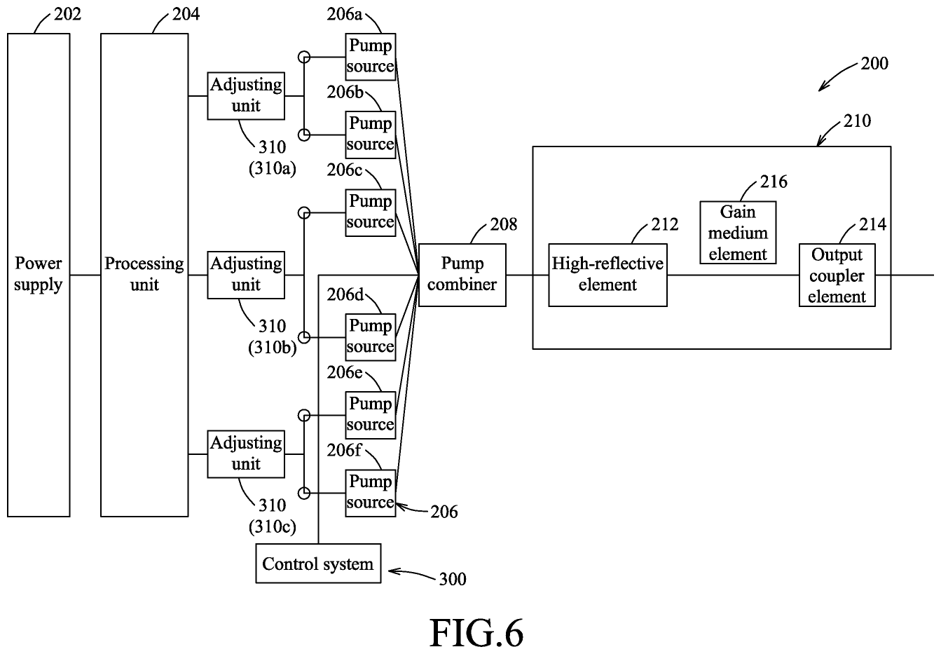

FIG. 6 is a block diagram of a control system 300 for a laser source (e.g., the laser source 200) according to one embodiment of the disclosure.

In this embodiment, the preset power value associated with the output laser signal of the laser source 200 is 600 watts, and in order to achieve such an output power, six pump sources 206 are present (labeled 206a to 206f). In examples where an output laser signal of 1200 watts is needed, 12 pump sources 206 may be employed.

In order to keep the cost of building the laser source 200 low, the number of power supplies 202 is typically kept at a minimum. As such, the number of power supplies 202 is almost always less than the number of the pump sources 206. In the example of FIG. 6, one power supply 202 is present.

In order to enable all six pump sources 206 to be fed with the input power within the capability of the power supply 202, the pump sources 206 may be connected in parallel to receive the input power. In the example of FIG. 6, the pump sources 206 are arranged into three parallel connections.

It is noted that the pump sources 206 may have properties (e.g., a light conversion efficiency) different from each other, and since only one power supply 202 is present, all six pump sources 206 receive the same input power, which may result in excessive input power being fed into some of the pump sources 206 and reducing the long-term stability of the laser source 200.

In this embodiment, the control system 300 further includes a plurality of adjusting units 310 that are each connected between the processing unit 204 and at least one of the pump sources 206. In this embodiment, three adjusting units 310 (labeled 310a to 310c) are present for the three parallel connections, respectively. It is noted that in some embodiments, six adjusting units 310 may be present for the six pump sources 206, respectively, and each of the adjusting units 310 is connected between the processing unit 204 and the respective one of the pump sources 206.

Each of the adjusting units 310 is configured to receive the input power and to adjust the input power to output an adjusted power. For each of the adjusting units 310, the input power is adjusted based on the properties of the at least one pump source 206 that is connected to the adjusting unit 310 (two pump sources 206 in this embodiment), and accordingly, the adjusted power thus obtained is dedicated for the at least one pump source 206 that is connected to the adjusting unit 310.

In one example, the input power outputted by the processing unit 204 is set based on the light conversion efficiencies of the pump sources 206. Specifically, the light conversion efficiencies of the pump sources 206 may be measured beforehand, and the input power outputted by the processing unit 204 is set based on a lowest one of the light conversion efficiencies of the pump sources 206 (for example, the light conversion efficiency of the pump source 206a). In such a case, this input power may exceed a normal working range for some of the pump sources 206 with better light conversion efficiencies (for example, the pump source 206f). As such, the adjusting units 310 may be configured such that the adjusted power outputted by the adjusting unit 310c is slightly lower than the adjusted power outputted by the adjusting unit 310a. Using this configuration, each of the pump sources 206 may be supplied with a customized input power (i.e., the adjusted power) that fits the unique light conversion efficiency thereof.

To sum up, embodiments of the disclosure provide a control system for a laser source, with the control system being configured to measure the output power of the output laser signal outputted by the laser source by detecting the leakage light signal escaping from the optical resonator instead of placing an additional element (e.g., an optical splitter) directly on the path of the output laser signal. In this manner, the optical splitter 122 of the conventional laser source 100 may be omitted.

Also, the measured output power of the output laser signal may be instantly compared with the preset value to determine whether an adjustment on the input power is needed to maintain a stable output power, and to determine whether one or more of the components are non-functional and the laser source needs to be shut down.

In some cases, the control system further includes a plurality of adjusting units for providing customized input power for each of the pump sources, while keeping the number of power sources at a minimum.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A control system for a laser source, the laser source including a processing unit, a plurality of pump sources that are connected to and controlled by the processing unit to output a light signal, a pump combiner that includes a plurality of input ports connected to the plurality of pump sources, respectively, and a signal transmission port, an optical resonator that receives pump light from the pump combiner and that outputs an output laser signal, the control system comprising:
a light extraction unit connected to the signal transmission port, said light extraction unit being configured to detect a leakage light signal from the optical resonator via the pump combiner to obtain a light parameter associated with the leakage light signal;
a microprocessor unit that is connected to said light extraction unit to receive the light parameter from said light extraction unit, and that is configured to determine an output power of the output laser signal based on the light parameter;
wherein said microprocessor unit is further connected to the processing unit, and is configured to
determine whether the output power of the output laser signal differs from a preset power value, and
when it is determined that the output power of the output laser signal differs from the preset power value, transmit an adjustment signal to the processing unit, so as to enable the processing unit to adjust an input power supplied to the plurality of pump sources in a manner that the input power results in the output power of the output laser signal being equal to the preset power value.

2. The control system of claim 1, wherein the light parameter is a leakage voltage.

3. The control system of claim 1, wherein said microprocessor unit is further configured to:
determine a difference between the output power of the output laser signal and the preset power value, and when it is determined that the difference is larger than a preset threshold, transmit a stop signal to the processing unit, so as to enable the processing unit to stop transmitting the input power to each of the plurality of pump sources.

4. The control system of claim 1, wherein said microprocessor unit includes a circuit block for performing the operations of determining whether the output power of the output laser signal differs from the preset power value.

5. The control system of claim 1, wherein said microprocessor unit includes a microprocessor that executes firmware instructions for performing the operations of determining whether the output power of the output laser signal differs from the preset power value.

6. The control system of claim 1, the processing unit of the laser source being connected to a power supply that provides a power signal to each of the plurality of pump sources, the control system further comprising:
a plurality of adjusting units, each being connected between the processing unit and a respective one of the pump sources, wherein each of said adjusting units is configured to receive the input power and to adjust the input power to output an adjusted power based on a light conversion efficiency of the respective one of the pump sources.

7. A method for controlling a laser source, the laser source including a processing unit, a plurality of pump sources that are connected to and controlled by the processing unit to output a light signal, a pump combiner that includes a plurality of input ports connected to the plurality of pump sources, respectively, and an optical resonator that receives pump light from the pump combiner and that outputs an output laser signal, the method being implemented using a control system connected to one of the input ports and comprising steps of:
a) detecting a leakage light signal from the optical resonator via the pump combiner, and obtaining a light parameter associated with the leakage light signal;
b) determining an output power of the output laser signal based on the light parameter;
c) determining whether the output power of the output laser signal differs from a preset power value; and
d) when it is determined that the output power of the output laser signal differs from the preset power value, transmitting an adjustment signal to the processing unit, so as to enable the processing unit to adjust an input power supplied to the pump sources in a manner that results in the output power of the output laser signal being equal to the preset power value.

8. The method of claim 7, the processing unit of the laser source being connected to a power supply that provides a power signal to each of the plurality of pump sources, the method further comprising, prior to step a), steps of:
e) under a specific value of input power, measuring, using an optical power meter connected to an output node of the optical resonator, a corresponding output power of the output laser signal, measuring the leakage light signal from the optical resonator via the pump combiner and obtaining a corresponding light parameter associated with the leakage light signal;
f) recording a set of source data, the set of source data including the specific value of input power, the corresponding output power and the corresponding light parameter;
repeating steps e) and f) multiple times, each time under a different value of input power to obtain multiple sets of source data; and
constructing one of a lookup table and a polynomial equation that indicates a relationship among the input power, the output power and the light parameter using the sets of source data.

9. The method of claim 7, wherein step a) includes obtaining a leakage voltage that serves as the light parameter.

10. The method of claim 7, further comprising:
determining a difference between the output power of the output laser signal and the preset power value, and when it is determined that the difference is larger than a preset threshold, transmitting a stop signal to the processing unit, so as to enable the processing unit to stop transmitting the input power to each of the plurality of pump sources.

11. The method of claim 7, wherein step c) includes using a circuit block to perform the operations of determining whether the output power of the output laser signal differs from the preset power value.

12. The method of claim 7, wherein step c) includes using a microprocessor that executes firmware instructions to perform the operations of determining whether the output power of the output laser signal differs from the preset power value.

13. The method of claim 7, the processing unit of the laser source being connected to a power supply that provides a power signal to each of the plurality of pump sources, the method further comprising:
receiving, by a plurality of adjusting units each connected between the processing unit and a respective one of the pump sources, the input power from the processing unit; and
adjusting, by each of the plurality of adjusting units, the input power to output an adjusted power, based on a light conversion efficiency of the respective one of the pump sources that is connected to the adjustment unit.
